(19) United States
(12) Patent Application Publication
(10) Pub. No.: US 2026/0008874 A1
(43) Pub. Date: Jan. 8, 2026

(54) HIGH-PRESSURE POLYMERIZATION PROCESS WITH CONTROLLED GAS VELOCITY

(71) Applicant: Basell Polyolefine GmbH, Wesseling (DE)

(72) Inventors: Danir Khayrullin, Frankfurt (DE); Juergen Mohrbutter, Frankfurt (DE); Christoph Wolf, Frankfurt (DE); Andre-Armand Finette, Frankfurt (DE); Michael Deuerling, Frankfurt (DE); Sven Wolfram, Frankfurt (DE)

(73) Assignee: Basell Polyolefine GmbH, Wesseling (DE)

(21) Appl. No.: 19/126,272

(22) PCT Filed: Oct. 31, 2023
(86) PCT No.: PCT/EP2023/080432

§ 371 Date: May 1, 2025

(30) Foreign Application Priority Data
Nov. 1, 2022 (EP) 22204851.4

(51) Int. Cl. C08F 10/00; B01J 3/04; C08F 2/01

(52) U.S. Cl. CPC C08F 10/00; B01J 3/04; C08F 2/01; B01J 2204/002; B01J 2204/007; B01J 2219/00033; B01J 2219/00164; C08F 2400/02; C08F 2400/04

(57) ABSTRACT

A process for polymerizing or copolymerizing one or more ethylenically unsaturated monomers with a controlled gas velocity of the gaseous reaction. A process for polymerizing or copolymerizing one or more ethylenically unsaturated monomers at temperatures from 100 to 350 ° C. and pressures in the range from 110 to 500 MPa, comprising the steps of: (a) compressing a gaseous reaction mixture in a hyper compressor, (b) providing the reaction mixture to each compressing stage through a suction pipe system, and (c) discharging the compressed reaction mixture from the compressing stage through a discharge pipe system.

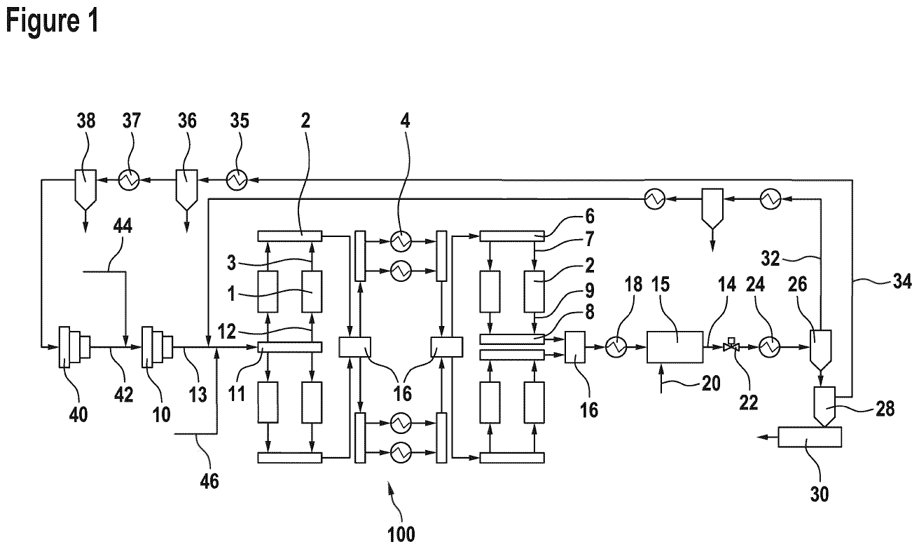

### FIELD OF THE DISCLOSURE

In general, the present disclosure relates to the field of chemistry. More specifically, the present disclosure relates to polymer chemistry. In particular, the present disclosure relates to a process for the polymerization or copolymerization of one or more ethylenically unsaturated monomers with a controlled gas velocity of the gaseous reaction.

### BACKGROUND OF THE DISCLOSURE

In some instances, polymers are obtained by high-pressure polymerization. In some instances, olefin monomers such as ethylene, optionally in combination with one or more comonomers, are polymerized into polyolefin products. Polyethylene is prepared by different processes. In some instances, the process includes polymerization in the presence of free-radical initiators at elevated pressures.

In some instances, the set-up for preparing polyethylene includes a polymerization reactor and additional equipment. In some instances, the polymerization reactor is an autoclave or a tubular reactor. In some instances, the setup includes a combination of such reactors. In some instances and for pressurizing the reaction components, a set of two compressors (that is, a primary compressor and a secondary, or hyper, compressor) is used. In some instances and at the end of the polymerization sequence, a set-up for high-pressure polymerization further includes apparatuses like extruders and granulators for pelletizing the resulting polymer. In some instances, the set-up includes systems for feeding monomers and comonomers, free-radical initiators, modifiers or other substances at one or more positions to the polymerization reaction.

In some instances, the secondary compressor causes a pulsation of the gaseous reaction mixture at the suction and discharge side of the hyper compressor cylinders, which, in turn, causes the connected pipework containing the gaseous reaction mixture to vibrate. It is believed that, in some instances, these pulsations and vibrations adversely affect plant performance. In some instances, increased gas pulsations reduce the lifetime of the cylinders of the compressors. In some instances, measures are employed to avoid damage from vibrations to piping arrangements and support structures.

### SUMMARY OF THE INVENTION

In a general embodiment, the present disclosure provides a process for polymerizing or copolymerizing one or more ethylenically unsaturated monomers at temperatures from 100 to 350° C. and pressures in the range from 110 to 500 MPa, wherein
(a) a gaseous reaction mixture is compressed in a hyper compressor having
   a first compressing stage including at least two cylinders being connected to a first stage discharge collection and distribution system via a first stage discharge pipe system;
   a second compressing stage including at least two cylinders being connected to (i) a second stage suction collection and distribution system via a second stage suction pipe system and (ii) a second stage discharge collection and distribution system via a second stage discharge pipe system; and
   a heat exchanger arranged between the first compressing stage and the second compressing stage;
(b) the reaction mixture is provided to each compressing stage through a suction pipe system and the compressed reaction mixture is discharged from the compressing stage through a discharge pipe system; and
(c) certain gas-reaction-mixture velocities are as follows. the velocity of the gaseous reaction mixture in the first stage discharge pipe system is from 0.8 m/s to 2.5 m/s; or
   the velocity of the gaseous reaction mixture in the first stage discharge collection and distribution system is from 2 m/s to 4 m/s; or
   the velocity of the gaseous reaction mixture in the second stage discharge pipe system is from 0.8 m/s to 3.5 m/s; or
   the velocity of the gaseous reaction mixture in the second stage discharge collection and distribution system is from 4 m/s to 9 m/s; or
   a combination thereof.

In some embodiments, the gaseous reaction mixture is conveyed from the heat exchanger to a mixing block before entering the second stage suction collection and distribution system.

In some embodiments, the velocity of the gaseous reaction mixture in the first stage discharge pipe system is less than 1.7 m/s.

In some embodiments, the velocity of the gas reaction mixture in first stage discharge collection and distribution system is less than 3.5 m/s.

In some embodiments, the velocity of the gaseous reaction mixture in the second stage discharge pipe system is less than 2.5 m/s.

In some embodiments, the velocity of the gaseous reaction mixture in the second stage discharge collection and distribution system is less than 7 m/s.

In some embodiments, the inner diameter of the pipes in the second stage discharge pipe system is smaller than the inner diameter of the pipes in the first stage discharge pipe system. In some embodiments, the inner diameter of the pipes in the first stage discharge pipe system is from 100 to 200 mm, alternatively from 120 to 160 mm. In some embodiments, the inner diameter of the second stage discharge pipe system is around 30 to 100 mm, alternatively from 50 to 89 mm.

In some embodiments, the velocity of the gaseous reaction mixture in the second stage discharge pipe system is higher than the velocity of the gaseous mixture in the first stage discharge pipe system. In some embodiments, the velocity of the gaseous mixture in the second stage discharge pipe system is from 0.9 to 3.5 m/s, alternatively from 1 to 3.2 m/s.

In some embodiments, the second compression stage has more cylinders than the first compression stage.

In some embodiments, the first compressing stage is connected with a first stage suction collection and distribution system via a first stage suction pipe system, wherein (a) the velocity of the gaseous reaction mixture in the first stage suction pipe system is between 0.5 m/s and 3 m/s, alternatively less than 1.5; (b) the velocity of the gaseous reaction mixture in the first stage suction collection and distribution system is between 3 m/s and 7 m/s, alternatively less than 6 m/s; or (c) both.

In some embodiments, (a) the velocity of the gaseous reaction mixture in the second stage suction pipe system is from 0.5 m/s to 2.5 m/s, alternatively less than 1.5; or (b) the velocity of the gaseous reaction mixture in the second stage suction collection and distribution system is from 2 m/s to 3.5 m/s, alternatively less than 3 m/s; or (c) both.

In some embodiments, the gaseous reaction mixture is conveyed from the first stage discharge collection and distribution system through one or more mixing blocks before entering the heat exchanger.

In some embodiments, the gaseous reaction mixture is conveyed from the second stage discharge collection and distribution system through one or more mixing blocks before being conveyed to a polymerization reactor.

In some embodiments, the compressor system further includes a pipe for providing the gaseous reaction mixture to the first stage suction collection and distribution system. In some embodiments, the gas velocity in the pipe is from 3 to 7 m/s, alternatively less than 6 m/s.

In some embodiments, the compressor system further includes a pipe for discharging the gaseous reaction mixture from the second stage collection and distribution system. In some embodiments, the gas velocity in the pipe is from 10 to 16 m/s.

In some embodiments, the gaseous reaction mixture is compressed in a primary compressor before entering the hyper compressor.

In some embodiments, the present disclosure further provides a high-pressure polymerization apparatus for polymerizing or copolymerizing one or more ethylenically unsaturated monomers, including a hyper compressor for compressing a gaseous reaction mixture, wherein
the hyper compressor having
   a first compressing stage including at least two cylinders being connected to a first stage discharge gas collection and distribution system via a first stage discharge pipe system;
   a second compressing stage including at least two cylinders being connected to (i) a second stage suction gas collection and distribution system via a second stage suction pipe system and (ii) a second stage discharge gas collection and distribution system via a second stage discharge pipe system; and
   a heat exchanger arranged between the first compressing stage and the second compressing stage.

### BRIEF DESCRIPTION OF THE DRAWINGS

The Figure is a schematic of a process for the polymerization or copolymerization of one or more ethylenically unsaturated monomers with a controlled gas velocity of the gaseous reaction.

### DETAILED DESCRIPTION OF THE DISCLOSURE

In some embodiments, the present disclosure provides a process for the high-pressure polymerization or copolymerization of one or more ethylenically unsaturated monomers. In some embodiments, the high-pressure polymerization is carried out at pressures of from 110 MPa to 500 MPa, alternatively from 160 MPa to 350 MPa, alternatively from 200 MPa to 330 MPa, in a tubular reactor. In some embodiments, the high-pressure polymerization is carried out at pressures of from 110 MPa to 300 MPa, alternatively from 120 MPa to 280 MPa, in an autoclave reactor. In some embodiments, the polymerization temperatures are in the range of from 100° C. to 350° C., alternatively from 180° C. to 350° C., alternatively from 200° C. to 330° C., in a tubular reactor. In some embodiments, the polymerization temperatures are in the range of from 110° C. to 320° C. in an autoclave reactor.

In some embodiments, the polymerization is a homopolymerization of ethylene or a copolymerization of ethylene with one or more other monomers, provided that these monomers are free-radically copolymerizable with ethylene under high pressure. In some embodiments, copolymerizable monomers are selected from the group consisting of α,β-unsaturated C₃-C₈-carboxylic acids, derivatives of α,β-unsaturated C₃-C₈-carboxylic acids, and 1-olefins. In some embodiments, the derivatives of α,β-unsaturated C₃-C₈-carboxylic acids are unsaturated C₃-C₁₅-carboxylic esters or anhydrides. In some embodiments, vinyl carboxylates are used as comonomers. In some embodiments, the vinyl carboxylate is vinyl acetate. In some embodiments, the comonomer is selected from the group consisting of propene, 1-butene, 1-hexene, acrylic acid, n-butyl acrylate, tert-butyl acrylate, 2-ethylhexyl acrylate, vinyl acetate, and vinyl propionate.

In some embodiments and in the case of copolymerization, the proportion of comonomer or comonomers in the reaction mixture is from 1 to 50% by weight, alternatively from 3 to 40% by weight, based on the amounts of monomers, that is, the sum of ethylene and other monomers.

As used herein, the terms “polymers or polymeric materials” refer to substances made up of at least two monomer units. In some embodiments, the polymers or polymeric materials are low density polyethylenes, having an average molecular weight Mₙ of more than 20 000 g/mole. As used herein, the term “low density polyethylene” (LDPE) includes ethylene homopolymers and ethylene copolymers. In some embodiments, the process results in the preparation of oligomers. waxes and polymers having a molecular weight Mₙ of less than 20 000 g/mole. In some embodiments, the polymerization is a radical polymerization carried out in the presence of free-radical polymerization initiators. In some embodiments, initiators for starting the polymerization in the respective reaction zones are substances capable of producing radical species under the conditions in the polymerization reactor. In some embodiments, the initiators are selected from the group consisting of oxygen, air, azo compounds, and peroxidic polymerization initiators. In some embodiments, the polymerization is carried out by using oxygen, either fed in the form of pure O₂ or as air. In some embodiments and when initiating the polymerization with oxygen, the initiator is first mixed with the ethylene feed and then fed to the reactor. In some embodiments, a stream made from or containing monomer and oxygen is fed to the beginning of the polymerization reactor, to one or more points along the reactor creating two or more reaction zones, or both. In some embodiments, initiation uses organic peroxides or azo compounds. In some embodiments, an individual initiator or mixtures of various initiators are used.

In some embodiments and in the high-pressure polymerization, the molecular weight of the polymers is altered. In some embodiments, the molecular weight of the polymers is altered by the addition of modifiers, which act as chain-transfer agents. In some embodiments, modifiers are selected from the group consisting of hydrogen, aliphatic and olefinic hydrocarbons, ketones, aldehydes, and saturated aliphatic alcohols. In some embodiments, the hydrocarbons are selected from the group consisting of propane, butane, pentane, hexane, cyclohexane, propene. 1-butene, 1-pentene, and 1-hexene. In some embodiments, the ketones are selected from the group consisting of acetone. methyl ethyl ketone (2-butanone), methyl isobutyl ketone, methyl isoamyl ketone, diethyl ketone, and diamyl ketone. In some embodiments, the aldehydes are selected from the group consisting of formaldehyde, acetaldehyde, and propionaldehyde. In some embodiments, the saturated aliphatic alcohols are selected from the group consisting of methanol, ethanol, propanol, isopropanol, and butanol. In some embodiments, modifiers are selected from the group consisting of saturated aliphatic aldehydes. 1-olefins, and aliphatic hydrocarbons. In some embodiments, the saturated aliphatic aldehyde is propionaldehyde. In some embodiments, the 1-olefins are selected from the group consisting of propene, 1-butene, and 1-hexene. In some embodiments, the aliphatic hydrocarbon is propane.

In some embodiments, a gaseous reaction mixture made from or containing the monomer feed is compressed in a hyper compressor, which having a first compressing stage including at least two cylinders being connected to a first stage discharge collection and distribution system via a first stage discharge pipe system; a second compressing stage including at least two cylinders being connected to (i) a second stage suction collection and distribution system via a second stage suction pipe system and (ii) a second stage discharge collection and distribution system via a second stage discharge pipe system; and at least one heat exchanger arranged between the first compressing stage and the second compressing stage. In some embodiments, the gaseous reaction mixture is provided to each compressing stage through a suction pipe system and the compressed reaction mixture is discharged from the compressing stage through a discharge pipe system.

In some embodiments, the collection and distribution systems are selected from the group consisting of a cross-connect pipe, a cross-connect block, and a high-pressure manifold.

In some embodiments, the gaseous reaction mixture is introduced into the first compressing stage via a first stage suction pipe system and discharged from the first compression stage via a first stage discharge system to a first stage discharge collection and distribution system. In some embodiments, the gaseous reaction mixture is conveyed to at least one heat exchanger before entering the second stage compressing system via a second stage suction collection and distribution system and introduced via a second stage suction pipe system into the second compressing stage. In some embodiments, the gaseous reaction mixture leaves the second compressing stage via a second stage discharge pipe to a second stage discharge collection and distribution system.

In some embodiments, controlling the velocity of the gaseous reaction mixture and collecting the gaseous reaction mixture discharged from the cylinders in a collection and distribution system reduces gas pulsation and vibration of the whole system. In some embodiments, the process provides a steady flow of the gaseous reaction mixture with reduced pulsation while maintaining heat transfer in the one or more heat exchangers.

In some embodiments, the gas velocity of the gaseous reaction mixture is controlled within the following ranges:
the velocity of the gaseous reaction mixture in the first stage discharge pipe system is from 0.8 m/s to 2.5 m/s; or
the velocity of the gaseous reaction mixture in the first stage discharge collection and distribution system is from 2 m/s to 4 m/s; or
the velocity of the gaseous reaction mixture in the second stage discharge pipe system is from 0.8 m/s to 3.5 m/s; or
the velocity of the gaseous reaction mixture in the second stage discharge collection and distribution system is from 4 m/s to 9 m/s; or
a combination thereof.

In some embodiments, the gas velocities within the claimed ranges provided the dampening effects without adversely affecting the process performance.

In some embodiments, the velocity of the gaseous reaction mixture in the first stage discharge pipe system is less than 1.7 m/s.

In some embodiments, the velocity of the gaseous reaction mixture in the first discharge collection and distribution system is less than 3.5 m/s.

In some embodiments, the velocity of the gaseous reaction mixture in the second stage discharge pipe system is less than 2.5 m/s.

In some embodiments, the velocity of the gaseous reaction mixture in the second stage discharge collection and distribution system is less than 7 m/s.

In some embodiments, the gaseous reaction mixture is compressed in the first compression stage to a pressure of from about 30 MPa to about 120 MPa, and in the second stage, the gaseous reaction mixture is further compressed to from about 120 MPa to the final polymerization pressure.

In some embodiments and further the dampening effect, the gaseous reaction mixture passes through additional collection and distribution systems. In some embodiments, the first stage compressing stage is connected with a first stage suction collection and distribution system via the first stage suction pipe system. In some embodiments, the velocity of the gaseous reaction in the first stage suction pipe system is between 0.5 and 3 m/s, alternatively less than 1.5. In some embodiments, the velocity of the gaseous reaction mixture in the first stage suction collection and distribution system is between 3 m/s and 7 m/s, alternatively less than 6 m/s.

In some embodiments, the second compressing stage is connected with a second stage suction collection and distribution system via a second stage suction pipe system. In some embodiments, the velocity of the gaseous reaction mixture in the second stage suction pipe system ranges from 0.5 m/s to 2.5 m/s, alternatively is less than 1.5. In some embodiments, the velocity of the gaseous reaction mixture in the second stage suction collection and distribution system is from 2 m/s to 3.5 m/s, alternatively less than 3 m/s.

In some embodiments, the gaseous reaction mixture passes through a number of mixing blocks. In some embodiments, passing the gaseous reaction mixture through a number of mixing blocks further dampens pulsation of the gaseous reaction mixture. In some embodiments, gaseous reaction mixtures discharged from the individual cylinders of the first compressing stage and the second compressing stage are combined. In some embodiments, the gaseous reaction mixture is conveyed from the first stage discharge collection and distribution system through at least one mixing block before entering the at least one heat exchanger. In some embodiments, the gaseous reaction mixture is conveyed at a gas velocity of 2 to 4 m/s, alternatively less than 3.5 m/s, from the first compressing stage to the at least one heat exchanger. In some embodiments, the gaseous reaction mixture is conveyed from the first compressing stage to the at least one heat exchanger via one or more mixing blocks.

In some embodiments and when leaving the second compressing stage, the gaseous reaction mixture is conveyed from the second stage discharge collection and distribution system through at least one mixing block before being conveyed to a polymerization reactor. In some embodiments, the gaseous reaction mixture is conveyed at a gas velocity of 2 to 3.5 m/s, alternatively less than 3 m/s, from the second stage discharge collection and distribution system to the polymerization reactor. In some embodiments, the gaseous reaction mixture is conveyed from the second stage discharge collection and distribution system to the polymerization reactor via one or more mixing blocks.

In some embodiments, the gaseous reaction mixture is conveyed from the heat exchanger to one or more mixing blocks before entering the second stage suction collection and distribution system. In some embodiments, the compressor system further has a pipe for providing the reaction mixture to the first stage suction collection and distribution system. In some embodiments, the gas velocity in the pipe is from 3 to 7 m/s.

In some embodiments, the compressor system further has a pipe for discharging the reaction mixture from the second stage collection and distribution system. In some embodiments, the gas velocity in the pipe is from 10 to 16 m/s.

In some embodiments, the gaseous reaction mixture is compressed in a primary compressor before entering the hyper compressor. In some embodiments, the gaseous reaction mixture is compressed in the primary compressor to a pressure of from 10 MPa to 50 MPa. In some embodiments, the primary compressor includes five or six compression stages. In some embodiments, fresh feed of ethylenically unsaturated monomers is introduced. In some embodiments, the ethylenically unsaturated monomer is ethylene. In some embodiments, the combined gases are compressed. In some embodiments, the primary compressor has two or three compressing stages before adding the fresh gas and two or three compressing stages after adding the fresh gas.

In some embodiments, fresh monomer feed is introduced into the gaseous reaction mixture before the combined mixture enters the hyper compressor.

In some embodiments, the entire reaction gas composition provided by the hyper compressor is fed via a pre-heater to the inlet of a polymerization reactor. In some embodiments, a part of the reaction gas composition compressed by the hyper compressor is fed via the pre-heater to the inlet of the polymerization reactor and the remainder of the reaction gas composition compressed by the hyper compressor is fed as one or more side streams to the polymerization reactor downstream of the inlet of the polymerization reactor. In some embodiments, from 30 to 90% by weight, alternatively from 40 to 70% by weight, of the reaction gas composition provided by the hyper compressor is fed to the inlet of the polymerization reactor and from 10 to 70% by weight, alternatively from 30 to 60% by weight, of the reaction gas composition provided by the hyper compressor is fed as one or more side streams to the polymerization reactor downstream of the inlet of the tubular reactor.

In some embodiments, the present disclosure provides a high-pressure polymerization apparatus for polymerizing or copolymerizing one or more ethylenically unsaturated monomers. In some embodiments, the apparatus includes a hyper compressor for compressing a gaseous reaction mixture, wherein
the hyper compressor having
   a first compressing stage including at least two cylinders being connected to a first stage discharge gas collection and distribution system via a first stage discharge pipe system:
   a second compressing stage including at least two cylinders being connected to (i) a second stage suction gas collection and distribution system via a second stage suction pipe system and (ii) a second stage discharge gas collection and distribution system via a second stage discharge pipe system; and
   at least one heat exchanger arranged between the first compressing stage and the second compressing stage.

In some embodiments, the at least on heat exchanger is a double pipe heat exchanger.

In some embodiments and after leaving the hyper compressor, the compressed gaseous reaction mixture enters a high-pressure polymerization reactor, wherein the polymerization takes place. In some embodiments, the polymerization is carried out with various types of high-pressure reactors. In some embodiments, the high-pressure reactors are tubular reactors or autoclave reactors. In some embodiments, the polymerization is carried out in one or more tubular reactors, one or more autoclave reactors, or combinations of such reactors.

In some embodiments, the high-pressure autoclave reactors are stirred reactors and have a length-to-diameter ratio in a range from 2 to 30, alternatively from 2 to 20. In some embodiments, the autoclave reactors have one or more reaction zones, alternatively from 1 to 6 reaction zones, alternatively from 1 to 4 reaction zones. In some embodiments, the number of reaction zones depends on the number of agitator baffles, which separate individual mixed zones within the autoclave reactor. In some embodiments, the polymerization or a first polymerization is carried out in an autoclave reactor and the reaction mixture coming from the compressors is first passed through a pre-cooler before entering the autoclave reactor.

In some embodiments, tubular reactors are thick-walled pipes, which are from about 0.5 km to 4 km, alternatively from 1 km to 3 km, alternatively from 1.5 km to 2.5 km, long. In some embodiments, the inner diameter of the pipes is in the range of from about 30 mm to 120 mm, alternatively from 60 mm to 100 mm. In some embodiments, the tubular reactors have a length-to-diameter ratio of greater than 1000, alternatively from 10000 to 40000, alternatively from 25000 to 35000. In some embodiments, the tubular reactor has tubes of a length from 5 m to 25 m, alternatively from 10 m to 22 m, alternatively from 15 m to 20 m.

In some embodiments, the tubular reactors have at least two reaction zones, alternatively from 2 to 6 reaction zones, alternatively from 2 to 5 reaction zones. The number of reaction zones is given by the number of feeding points for the initiator. In some embodiments, the tubular reactor is equipped with cooling jackets for removing the heat of the reaction. In some embodiments, the reaction zones of the tubular reactor are cooled by cooling jackets.

In some embodiments, the apparatus includes a pre-heater upstream of a polymerization reactor for heating the reaction gas composition to a temperature capable of initiating the polymerization. In some embodiments, the pre-heater has tubes of a length from 5 m to 25 m, alternatively from 10 m to 22 m, alternatively from 15 m to 20 m. In some embodiments, the individual tubes of the pre-heater are flanged together. In some embodiments, the tubes are flanged to a bend. In some embodiments, the bend is a 180° bend.

In some embodiments, the apparatus for carrying out the polymerization of the present disclosure includes the polymerization reactor and two or more gas recycle lines for recycling unreacted monomers into the polymerization process. In some embodiments, the reaction mixture obtained in the polymerization reactor is transferred to a first separation vessel, also called high-pressure product separator, and separated into a gaseous fraction and a liquid fraction at an absolute pressure of from 15 MPa to 50 MPa. In some embodiments, the gaseous fraction is fed via a high-pressure gas recycle line to the suction side of the hyper compressor. In some embodiments and in the high-pressure gas recycle line, the gas is purified by several purification steps, thereby removing components such as entrained polymer or oligomers. In some embodiments, the liquid fraction is made from or containing dissolved monomers such as ethylene and comonomers in an amount of 20 to 40% of weight. In some embodiments, the liquid fraction is transferred to a second separation vessel, also called low-pressure product separator, and further separated, at reduced pressure into polymeric and gaseous components. In some embodiments, the reduced pressure is at an absolute pressure in the range of from 0.1 to 0.5 MPa. In some embodiments, the gaseous fraction withdrawn from the second separation vessel is fed via a so-called low-pressure gas recycle line to the primary compressor. In some embodiments, the gaseous fraction withdrawn from the second separation vessel is fed the low-pressure gas recycle line to the primary compressor to the foremost of the stages. In some embodiments, the low-pressure gas recycle line includes several purification steps for purifying the gas.

In some embodiments, the pressure within the polymerization reactor is controlled by a pressure control valve, which is arranged at the outlet of the polymerization reactor and through which the reaction mixture leaves the reactor. In some embodiments, the pressure control valve is a valve arrangement for reducing the pressure of the reaction mixture leaving the reactor to the pressure within the first separation vessel.

In some embodiments, the apparatus includes a post reactor cooler downstream of the polymerization reactor for cooling the reaction mixture. In some embodiments, the post reactor cooler is arranged upstream of the pressure control valve. In some embodiments, the post reactor cooler is arranged downstream of the pressure control valve. In some embodiments, the post reactor cooler has tubes of a length from 5 m to 25 m, alternatively from 10 m to 22 m, alternatively from 15 m to 20 m. In some embodiments, the individual tubes of the tubular reactor are flanged together.

The present disclosure will be described in more detail with reference to the Figure. However, the description is not intended to limit the scope and spirit of the disclosure.

In some embodiments, the gaseous reaction mixture made from or containing one or more ethylenically unsaturated monomers is introduced into a primary compressor 10 which is connected to a hyper compressor 100 having a first stage suction collection and distribution system 11 via pipe 13. From the first stage suction collection and distribution system 11, the gaseous reaction mixture is conveyed via first stage suction pipe system 12 to first compressing stage 1. The gaseous reaction mixture leaves the first compressing stage 1 via first stage discharge pipe system 3 to enter first discharge collection and distribution system 2 before entering heat exchanger 4 via one or more mixing blocks 16. After leaving heat exchanger 4, the gaseous reaction mixture passes through one or mixing blocks 16 and is conveyed to second stage suction collection and distribution system 6, which is connected to second compressing stage 2 via second stage suction pipe system 7. The compressed gaseous reaction mixture leaves the second compressing stage 2 via second stage discharge pipe 9 to enter the second stage discharge collection and distribution system 8. The compressed gaseous reaction mixture is conveyed to the polymerization reactor 15 via second stage discharge pipe system 14 while passing through one or mixing blocks 16 arranged between the second stage discharge collection and distribution system 8 and the polymerization reactor 15. In some embodiments, a preheater 18 is arranged between the mixing block 16 and the polymerization reactor 15.

In some embodiments, the reactor 15 has initiator injection points for feeding initiator mixtures to the reactor 15. In the Figure, an initiator feed is schematically shown with arrow 20. In some embodiments, the tubular reactor 15 has multiple spatially separated initiator injection points.

In some embodiments, the reaction mixture leaves the tubular reactor 15 through pressure control valve 22 and passes a post reactor cooler 24. Thereafter, the resulting polymer is separated from unreacted ethylene and other low molecular weight compounds by a first separation vessel 26 and a second separation vessel 28. In some embodiments, the other low molecular weight compounds are selected from the group consisting of monomers, oligomers, polymers, additives, and solvent. Next, the resulting polymer is discharged and pelletized via an extruder and granulator 30.

In some embodiments, the ethylene and comonomers, which were separated from the polymer in the first separation vessel 26, are fed back to the inlet end of the tube reactor 15 in the high-pressure circuit 32. In the high-pressure circuit 32, the gaseous material separated from the reaction mixture is first freed from other constituents in at least one purification stage and then added to the monomer stream between primary compressor 10 and hyper compressor 100. In some embodiments, the high-pressure circuit 32 separates the solvent from waxes.

In some embodiments, the mixture of ethylene, very low molecular weight products of the polymerization (oligomers), and solvent, which were separated in the second separation vessel 28, is worked up in the low-pressure circuit 34, having a plurality of separators with a heat exchanger being arranged between each of the separators. The Figure shows two purification stages consisting of heat exchangers 35 and 37 and separators 36 and 38. In some embodiments, a single purification stage is used. In some embodiments, more than two purification stages are used. In some embodiments, the low-pressure circuit 34 separates oils, solvent and waxes. The worked up ethylene is first compressed in a booster compressor 40 and returned to the primary compressor 10 via line 42. In some embodiments, chain transfer agents (CTA) are added to the primary compressor together with the fresh ethylene via line 44. In some embodiments, comonomer is added upstream of the hyper compressor 100 via line 46.

1. A process for polymerizing or copolymerizing one or more ethylenically unsaturated monomers at temperatures from 100 to 350° C, and pressures in the range from 110 to 500 MPa, wherein
(a) a gaseous reaction mixture is compressed in a hyper compressor comprising
(i) a first compressing stage comprising at least two cylinders being connected to a first stage discharge collection and distribution system via a first stage discharge pipe system;
(ii) a second compressing stage comprising at least two cylinders being connected to (i) a second stage suction collection and distribution system via a second stage suction pipe system and (ii) a second stage discharge collection and distribution system via a second stage discharge pipe system; and
(iii) a heat exchanger arranged between the first compressing stage and the second compressing stage;
(b) the reaction mixture is provided to each compressing stage through a suction pipe system and the compressed reaction mixture is discharged from the compressing stage through a discharge pipe system; and
(c) certain gas-reaction-mixture velocities are as follows
(i) the velocity of the gaseous reaction mixture in the first stage discharge pipe system is from 0.8 m/s to 2.5 m/s; or
(ii) the velocity of the gaseous reaction mixture in the first stage discharge collection and distribution system is from 2 m/s to 4 m/s; or
(iii) the velocity of the gaseous reaction mixture in the second stage discharge pipe system is from 0.8 m/s to 3.5 m/s; or
(iv) the velocity of the gaseous reaction mixture in the second stage discharge collection and distribution system is from 4 m/s to 9 m/s; or a combination thereof.

2. The process of claim 1, wherein the collection and distribution systems are selected from the group consisting of a cross-connect pipe, a cross-connect block, and a high-pressure manifold.

3. The process of claim 1, wherein the velocity of the gaseous reaction mixture in the first stage discharge pipe system is less than 1.7 m/s.

4. The process of claim 1, wherein the velocity of the gas reaction mixture in first stage discharge collection and distribution system is less than 3.5 m/s.

5. The process of claim 1, wherein the velocity of the gaseous reaction mixture in the second stage discharge pipe system is less than 2.5 m/s.

6. The process of claim 1, wherein the velocity of the gaseous reaction mixture in the second stage discharge collection and distribution system is less than 7 m/s.

7. The process of claim 1, wherein the first compressing stage is connected with a first stage suction collection and distribution system via a first stage suction pipe system, wherein (a) the velocity of the gaseous reaction mixture in the first stage suction pipe system is between 0.5 m/s and 3 m/s, (b) the velocity of the gaseous reaction mixture in the first stage suction collection and distribution system is between 3 m/s and 7 m/s, or (c) both.

8. The process of claim 1, wherein (a) the velocity of the gaseous reaction mixture in the second stage suction pipe system is from 0.5 m/s to 2.5 m/s, (b) the velocity of the gaseous reaction mixture in the second stage suction collection and distribution system is from 2 m/s to 3.5 m/s, or (c) both.

9. The process of claim 1, wherein the gaseous reaction mixture is conveyed from the first stage discharge collection and distribution system through one or more mixing blocks before entering the heat exchanger.

10. The process of claim 1, wherein the gaseous reaction mixture is conveyed from the second stage discharge collection and distribution system through one or more mixing blocks before being conveyed to a polymerization reactor.

11. The process of claim 1, wherein the gaseous reaction mixture is conveyed from the heat exchanger to one or more mixing blocks before entering the second stage suction collection and distribution system.

12. The process of claim 1, wherein the compressor system further comprises a pipe for providing the reaction mixture to the first stage suction collection and distribution system, wherein the gas velocity in said pipe is from 3 to 7 m/s.

13. The process of claim 1, wherein the compressor system further comprises a pipe for discharging the reaction mixture from the second stage collection and distribution system, wherein the gas velocity in said pipe is from 10 to 16 m/s.

14. The process of claim 1, wherein the gaseous reaction mixture is compressed in a primary compressor (before entering the hyper compressor.

15. The process of claim 1, wherein the velocity of the gaseous reaction mixture in the second stage discharge pipe system is higher than the velocity of the gaseous reaction mixture in the first stage discharge pipe system.
